(19) United States
(12) Patent Application Publication
(10) Pub. No.: US 2017/0286418 A1
(43) Pub. Date: Oct. 5, 2017

(54) METHOD AND SYSTEM FOR LOCALLY INDEXING AND SEARCHING FOR DIGITAL PHOTOS

(71) Applicant: Tal FLORENTIN, Petach Tikva (IL)

(72) Inventor: Tal FLORENTIN, Petach Tikva (IL)

(21) Appl. No.: 15/473,657

(22) Filed: Mar. 30, 2017

Related U.S. Application Data
(60) Provisional application No. 62/315,694, filed on Mar. 31, 2016.

(51) Int. Cl. G06F 17/30

(52) U.S. Cl. CPC G06F 17/3028; G06F 17/30283; G06F 17/30247

(57) ABSTRACT

Methods, systems, and products, such as software products, are provided for locally indexing photographs (e.g., digital photographs), stored in a user (local) computer. There is also a search mechanism, such as a search engine, for the local computer, allowing the user to easily find these now-indexed digital photographs on their local computer.

### CROSS-REFERENCES TO RELATED APPLICATIONS

This application is related to and claims priority from commonly owned U.S. Provisional Patent Application Ser. No. 62/315,694, entitled: METHOD AND SYSTEM FOR LOCALLY INDEXING AND SEARCHING FOR DIGITAL PHOTOS, filed on Mar. 31, 2016, the disclosure of which is incorporated by reference in its entirety herein.

### TECHNICAL FIELD

The present invention is directed to indexing systems for photos, images and stock photos, stored in computers and computer databases, such that these items can be accessed easily.

### BACKGROUND

Visual designers, User Experience (UX) designers and other professionals in the digital world use online stock photo service websites in order to find photos and include them in the created designs. The professionals go to one or more of the multiple stock photo services, that are available across the world wide web (WWW), and use their searching mechanisms and find relevant photos for their work. Once a photo is found, its file is purchased, when necessary, and downloaded to the local computer. The downloaded photos are typically saved locally in standard file folders.

Should some time pass since the last use of a sock photo stored in the user's computer, the user has to conduct a search for the photo. The stock photos are typically stored randomly, so searches could become frustrating and take a long time. As a result, users may give up the search and simply download previously purchased photos or purchase additional photos similar to those being searched for, from a stock photo web site.

### SUMMARY OF THE INVENTION

The present invention provides methods, systems, and products, such as software products, for locally indexing photographs (e.g., digital photographs), stored in a user (local) computer. For example, the indexed photographs are stored in a searchable database in user computer. The indexing is based on one or more of photograph content and photograph attributes. The present invention also provides a search mechanism, such as a search engine, for the local computer, allowing the user to easily find these now-indexed photographs (e.g., digital photographs) on their local computer.

The present invention also provides methods, systems, and products, such as software products, which allow users to search for indexed photos locally, in their local computer, based on the description and/or keywords and other attributes of the stock photograph itself, a local database (e.g., within the computer, or connected to or otherwise locally associated with the local (user) computer, such as within a limited area with respect to the user computer). The present invention is such that when a user selects a photo locally, a detailed panel shows the user enhanced photo with its attributes, and allows the user to copy the photo to the local computer's clipboard or open the folder containing the folder, for example, for further processes and operations. Also, the user can select local photos and mark them as favorites, and access these favorites (favorite photos) locally and directly.

Embodiments of the invention are directed to a method for creating a local database associated with a computer, and the computer is linked to a communications network. The method comprises: in a main folder associated with the computer, identifying stock photographs in the main folder, determining the online stock photo service for each of the identified stock photographs; accessing the stock photograph page for each of the identified stock photographs from a destination over the communications network; extracting data from the stock photograph page for each of the identified stock photographs, over the communications network; and, rendering the extracted data for each identified stock photograph as an indexed item for each identified stock photograph, in a local database associated with the computer.

Optionally, the method additionally comprises: creating the local database as associated with the computer, and storing the indexed item for each identified stock photograph, based on the extracted data, as a unique row in the local database.

Optionally, the extracted data includes at least one of: a description of the stock photograph and keywords associated with the stock photograph.

Optionally, the method additionally comprises: extracting attributes for each identified stock photograph from the main folder; and, rendering the extracted attributes for each identified stock photograph as an indexed item for each identified stock photograph, in a local database associated with the computer.

Optionally, the method additionally comprises: storing the indexed item for each identified stock photograph, based on the extracted attributes, in the unique row for the identified stock photograph, in the local database.

Optionally, the extracted attributes include at least one of: file format, photograph size in pixels, photograph size in kilobytes, keywords associated with the photograph, photograph file source, and date of download of the photograph.

Optionally, the method additionally comprises: prompting a user to define a folder as the main folder for stock photographs.

Optionally, the main folder includes at least one of: subfolders, photograph files, and data of photographs.

Optionally, the unique row for the identified stock photograph, in the local database includes metadata associated with the identified stock photograph, the metadata for the location of the data of the actual stock photograph.

Optionally, the destination includes a web site of at least one online stock photograph provider.

Optionally, the communications network includes the Internet.

Optionally, the computer includes a local computer.

Embodiments of the invention are directed to a computer usable non-transitory storage medium having a computer program embodied thereon for causing a suitable programmed system to create a local database associated with a local computer linked to a communications network, by performing the following steps when such program is executed on the system. The steps comprise: in a main folder associated with the computer, identifying stock photographs in the main folder, determining the online stock photo service for each of the identified stock photographs; accessing the stock photograph page for each of the identified stock photographs from a destination over the communications network; extracting data from the stock photograph page for each of the identified stock photographs, over the communications network; and, rendering the extracted data for each identified stock photograph as an indexed item for each identified stock photograph, in a local database associated with the computer.

Optionally, for the computer usable non-transitory storage medium, the steps additionally comprise: creating the local database as associated with the computer, and, storing the indexed item for each identified stock photograph, based on the extracted data, as a unique row in the local database.

Optionally, for the computer usable non-transitory storage medium, the extracted data includes at least one of: a description of the stock photograph and keywords associated with the stock photograph.

Optionally, for the computer usable non-transitory storage medium, the steps additionally, comprise: extracting attributes for each identified stock photograph from the main folder; and, rendering the extracted attributes for each identified stock photograph as an indexed item for each identified stock photograph, in a local database associated with the computer.

Optionally, for the computer usable non-transitory storage medium, the steps additionally comprise: storing the indexed item for each identified stock photograph, based on the extracted attributes, in the unique row for the identified stock photograph, in the local database.

Optionally, for the computer usable non-transitory storage medium, the extracted attributes includes at least one of: file format, photograph size in pixels, photograph size in kilobytes, keywords associated with the photograph, photograph file source, and date of download of the photograph.

Optionally, for the computer usable non-transitory storage medium, the steps additionally comprise: prompting a user to define a folder as the main folder for stock photographs; and, wherein the main folder includes at least one of: subfolders, photograph files, and data of photographs.

Optionally, for the computer usable non-transitory storage medium, the destination includes a web site of at least one online stock photograph provider.

This document references terms that are used consistently or interchangeably herein. These terms, including variations thereof, are as follows.

A “computer” includes machines, computers, and computing or computer systems (for example, physically separate locations or devices), servers, computer, computing, and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone (cellular and network linked), smart band, smart watch, virtual and augmented reality headsets, personal digital assistant (PDA)).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A “client” is an application that runs on a computer, workstation or the like and relies on a server to perform some of its operations or functionality.

“Metadata” is data that describes other data. For example, metadata may include data used to provide the address for stored data, such as the actual image data associated with photographs, video, and the like.

“n” and “nth” refer to the last member of a varying or potentially infinite series.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2 is a diagram of the architecture of the local computer, having downloaded the program of the present invention;

FIG. 3 is a flow diagram of an example process in accordance with embodiments of the present invention;

FIG. 4 is a flow diagram of another example process in accordance with embodiments of the present invention;

FIGS. 5A and 5B are screen shots of a subprocess of the flow diagram of FIG. 3; and,

FIGS. 5C and 5D are screen shots of the subprocesses of the flow diagram of FIG. 4.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

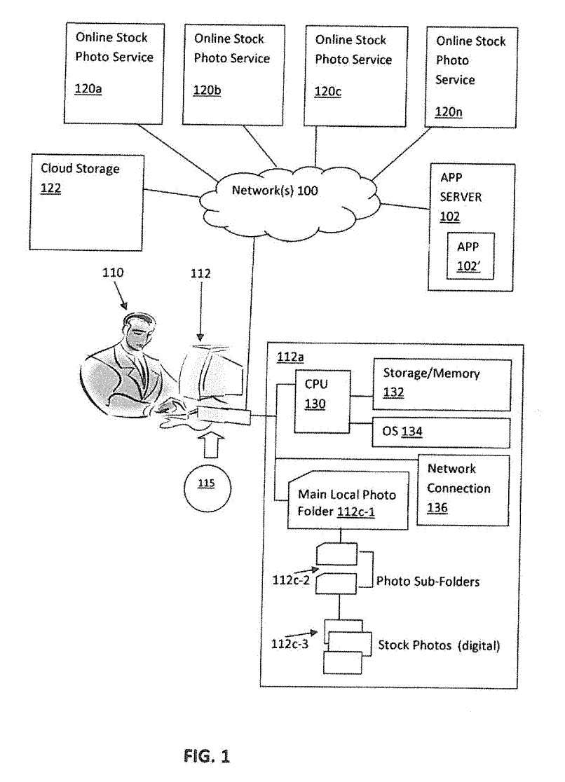

Reference is now made to FIG. 1, which shows an operating environment for a non-limiting exemplary system, also known as an application server 102, in accordance with some embodiments of the present invention. The non-limiting exemplary system is set to create a searchable index for all stock photographs (digital stock photographs) (“photographs” and “photos” used interchangeably herein) stored in a computer user's computer files, or other storage media. The application server 102 is shown linked over one or more networks, represented by the network(s) 100, either directly or indirectly. A user computer 112, representative of all user computers, also referred to as a local computer, as it is, for example, directly accessed by the user 110, is linked to the network(s) 100.

“Linked” as used herein includes both wired or wireless links, either direct or indirect, and placing the computers, including, servers, components and the like, in electronic and/or data communications with each other. The network(s) 100 is, for example, communications networks, such as a Local Area Network (LAN), or a Wide Area Network (WAN), including public networks such as the Internet. As shown in FIG. 1, the network(s) 100 is, for example, the Internet. The network(s) 100, although shown as a single network, may be a combination of networks and/or multiple networks including, for example, the Internet and cellular networks.

The application server 102 includes an application (APP) 102′, which is, for example, downloaded by users 110, to their machines, e.g., computer 112 (a local computer), over the network 100. The application 102′ provides indexing and a searchable index for all stock photographs (digital stock photographs or digital photographs), for example, stored as digital data, in a computer user's 110 computer files 112c-1, 112c-2, and/or other storage media, such as in cloud storage 122.

Embodiments of the present invention may also be stored on non-transitory (non-transient) storage media, represented, for example, by a compact disc 115. This compact disc (CD) 115 is adapted to be operated by the computer 112 of the user 110.

The application server 102 utilizes hardware, software, processors and various storage media for performing its operations.

Similarly, the computer 110 of the user 112, as shown in FIG. 1, prior to installation of the program, from either the APP 102′ or the non-transitory storage media, e.g., the compact disk 115, includes hardware, software, processors and various storage media for performing its operations. The computer 112 includes processors, such as PENTIUM® processors for its central processing unit (CPU) 130 (linked to storage/memory 132 for storing machine executable instructions for performing processor operations), and operating systems (OS) 134 such as those which are standard for personal computers, laptop computers, tablet computers and the like, such as Windows®, DOS and iOS. There is also a network communications module 136 controlled by the CPU 130, for handling data and other electronic communications, transmissions and the like, for the computer 112, over the network(s) 100. The computer 112 also includes storage media for a main folder 112c-1, subfolders 112c-2 of the main folder 112c-1 and digital stock photos 112c-3, and other local storage media (not shown) (associated with the computer 112).

Additionally, servers 120a-120n, which host online stock photo services, are linked to the network 100. Servers for cloud storage, for example, represented by server 122, are also linked to the network(s) 100.

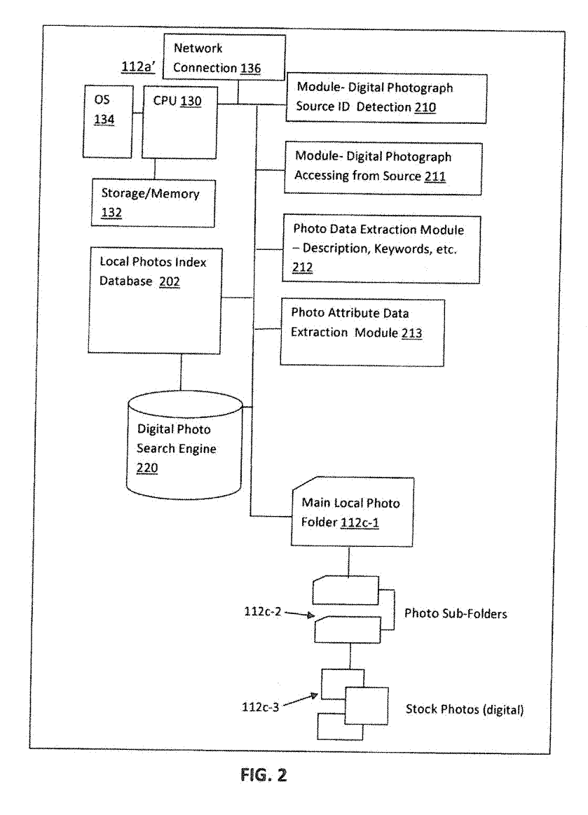

FIG. 2 shows the user computer 112a′ after the program from, for example, either the APP 102′ or the non-transitory storage media 115, has been installed on the computer 112, rendering the local computer 112, as a system for performing the processes of the present invention, referred to hereinafter as the “system”, and transforming the local computer 112 into a special purpose computer.

Initially, the user computer 112a′ (the “system”) for performing the present invention, as shown in FIG. 2 includes the CPU 130, Storage/Memory 132, Operating System (OS) 134, and Network connection module 136 as detailed for FIG. 1 above. Also included is the main local photo folder 112c-1, photo sub folders, 112c-2 and stock photos 112c-3, also detailed above for FIG. 1.

The installation of the program results in the creation of a local photos index database 202, where indexed photos and/or their associated metadata are stored. The database is searchable, for example, by the search engine 220. Modules for performing the disclosed processes include modules for digital photograph source identification (ID) 210, digital photo accessing over a network or other online connection 211, photo data extraction 212, and, photo attribute extraction 213. Also created by the program installation is a digital photo search engine 220, from which the now-indexed and locally stored photos, in the database 202, can be searched. These databases 202, modules 210, 211, 212, 213, and search engine 220, are described in greater detail below.

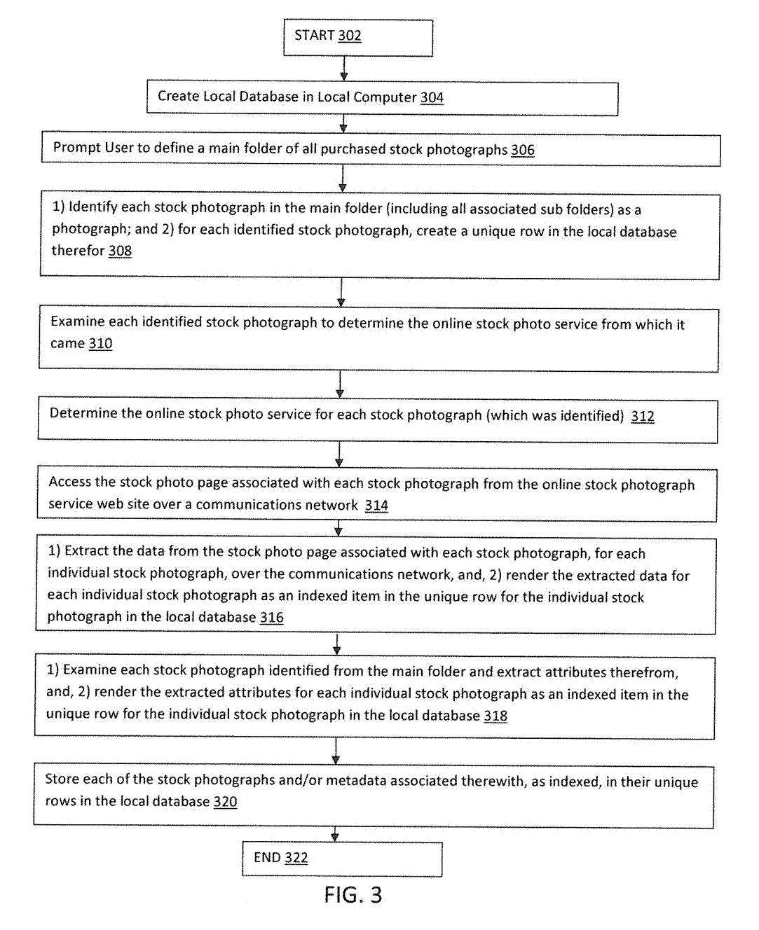

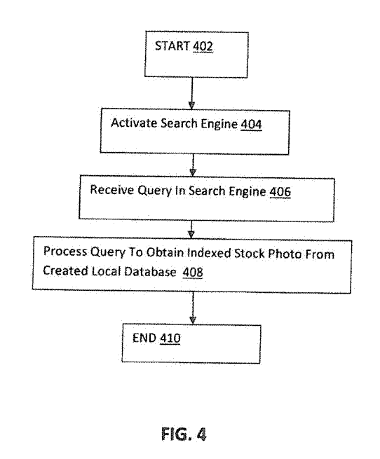

Attention is now directed to FIGS. 3 and 4, which show flow diagrams detailing computer-implemented processes in accordance with embodiments of the disclosed subject matter. Reference is also made to elements shown in FIGS. 1 and 2. The process and subprocesses of FIGS. 3 and 4, include computerized processes performed by the user computer 112, which upon downloading and executing the program, from either the application (APP) 102′ or the non-transitory storage media 115, render the user (local) computer as a special purpose computer, as shown in FIG. 2. The aforementioned processes are, for example, performed automatically or manually, or a combination thereof, and, for example, in real time.

The process begins at the START block 302. At this time, the user 110 installs the program of the present invention, for example, from the downloaded APP 102′ or the non-transitory storage media 115, locally on his (the user 110) computer 112 (local computer). The process moves to block 304, where the program, now installed, creates a local database 202 within the local computer 112. This database 202 is searchable, as the data associated with the each of the stock photos is indexed, for example as indexed items. For example, the local database 202 includes rows corresponding to each stock photograph and the various indexed items, and optionally, includes metadata (such as for the location (storage address) of the data of the stock photograph itself), associated with the stock photograph, so that the stock photograph is searchable. The user 110 starts the program on his computer 112.

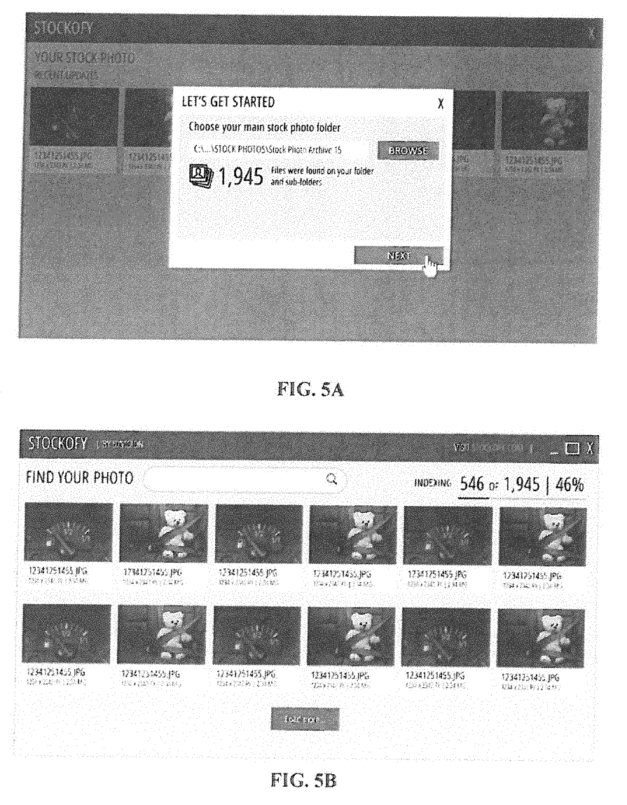

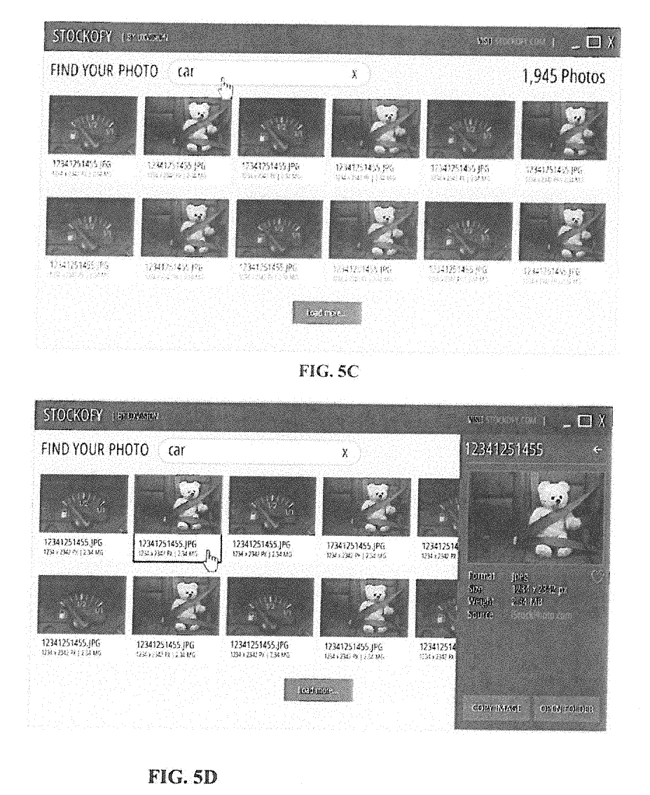

The process moves to block 306, where the program prompts the user 112 to define the main (source) folder 112c-1 which contains all of the photos 112c-3 (stored in digital format on the computer 112) that have been purchased or otherwise obtained from the different stock photo sources 120a-120n. This is shown by the screen shot of FIG. 5A. The main folder 112c-1 typically includes sub-folders 112c-2, which can include additional photos (in digital formats), and other photograph files, data of photographs, digital objects, and the like.

With the main folder 112c-1 defined, as entered by the user 110, all photos, in digital format, from the folders 112c-1, 112c-2 are, for example, obtained one by one, at block 308. At block 308, subprocesses occur, where: 1) each stock photograph in the main folder (including all associated sub folders) is identified as such; and, 2) for each identified stock photograph, a unique row in the local database 202 is created.

The process moves to block 310, where the indexing process now begins, so that the database 202 is indexed and searchable for the stock photographs. For each identified digital stock photo from the local computer 112, a unique row is created in the local photos index database 202. At block 310, each photo file is examined to determine which online source stock photo service 120a-120n, each individual photo was purchased from or otherwise came from. A determination is then made of the online (network) source for the identified digital stock photograph, for example, by the module 210, at block 312.

The process moves to block 314, where the program, for example, via module 211, accesses the specific photo page associated with or related to the specific (e.g., individual) stock photograph from a destination, e.g., the requisite online stock photograph service website 120a-120n, over the network(s) 100. Each photo page on the stock photograph service website 120a-120n includes, for example, a description of the stock photograph and keywords (for example, keyword lists), and the like, associated with the stock photograph. The aforementioned description and/or list of keywords are those on which the image of the stock photograph can be identified within the online stock photograph service website.

The program, for example, via module 212, extracts, for example, automatically, the data, for example, the description and/or keywords for the specific stock photograph from the associated stock photograph page at the website of the stock photograph service, at block 316. Also at block 316, the aforementioned extracted data (a description of the stock photograph, keywords and the like) is rendered as an indexed item in the unique row for the individual stock photograph in the local database 202. The indexed item is, for example, stored in the local database 202 (in the aforementioned unique row corresponding to its stock photograph).

The process moves to block 318, where, for example, the module 213, examines each stock photograph identified from the main folder and extracts attributes therefrom. The attributes include, for example, data such as the file format, the photograph/photograph file's size in pixels, the photograph/photograph file's size in kilobytes, the keywords associated with and/or attached to the photograph/photograph file, the photograph/photograph file's source and the date of download, and the like. For example, the module 213 then renders the extracted attributes for each individual stock photograph as an indexed item in the unique row for the individual stock photograph in the local database 202. The indexed item is, for example, stored in the local database 202 (in the aforementioned unique row corresponding to its stock photograph).

The process moves to block 320, where each of the stock photographs and/or metadata associated therewith, as indexed, is stored in the unique rows in the local database 202, corresponding to each stock photograph. The metadata, for example, is for the storage location of the data of the actual stock photograph. The metadata is coordinated with the indexed items and is indexed accordingly, so as to appear or be applied with query search results, as described for FIG. 4 below.

The data representing the stock photographs themselves, which is optionally mapped to the metadata for the respective photograph (photograph data), is stored, for example, in storage media, e.g., locally in the computer 112, such as in the other local storage media, in folders, files and the like locally, or in the cloud 122, for example, in network and/or distributed folders. However, the aforementioned data may also be stored in the database 202, or storage media associated therewith (not shown). The resultant indexing is shown graphically in the screen shot of FIG. 5B. The process now ends at block 322.

For example, the now-indexed photos may be shown as thumbnails of all of the user's 112 photos from the source folder and sub-folder, sorted by download date. Additionally, the program is such that the user can search for the photos locally, based on the description and/or keywords within the local database 202 (which includes photo metadata). Also, for each selected photo within the local program, a detailed panel shows the photo, enhanced with its attributes, and allows the user to copy the photo to the local computer's clipboard or open the folder containing the folder, for additional actions. In the local database 202, the now-indexed photos can be selected by the user 112 and marked as favorites, whereby the user can now directly access these favorite photographs.

Upon reopening the program (with the program running on the local computer 112), the program explores the source folder 112c-1 or sub folders 112c-2 and searches for any additional photos. If any additional photos were downloaded after the last time the program was run, the aforementioned indexing process is performed for each one of the additional photos loaded. Additionally, should the program find photos that have been removed from the source folder 112c-1 or sub folders 112c-2, the database 202 is updated accordingly.

Attention is now directed to the flow diagram of FIG. 4, which shows a process for searching for one or more digital photos indexed in accordance with the present invention, as detailed above. Initially, at the START block 402, the indexing process of the invention is complete, and the metadata of the photos, stored in the database 202 is linked to the data for the photos themselves, which are stored in local storage media as files, and/or in the cloud 122, for example, in network and/or distributed folders.

At block 404, the search engine 220 is activated and the user enters a search query.

The query is received by the computer system 112a′, and sent to the search engine 220, at block 406. This is shown, for example, in the screen shot of FIG. 5C.

The process moves to block 408, where the query is processed, by the search engine 220, to obtain the indexed digital stock photo from the created local database 202. The query processing includes searching the indexed items associated with each photograph as stored in the database 202, to obtain the requested stock photograph and/or metadata associated therewith. The searchable indexed items, include, for example, the extracted data and extracted attributes for the stock photographs (that may be, for example, tagged to the stock photographs or associated otherwise therewith), that match or otherwise satisfy the query, to obtain the requested stock photograph and typically includes the metadata associated therewith. The received result is shown, for example, in the screen shot of FIG. 5D. The process ends at block 410.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data.

Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for creating a local database associated with a computer, the computer linked to a communications network, comprising:
in a main folder associated with the computer, identifying stock photographs in the main folder;
determining the online stock photo service for each of the identified stock photographs;
accessing the stock photograph page for each of the identified stock photographs from a destination over the communications network;
extracting data from the stock photograph page for each of the identified stock photographs, over the communications network; and,
rendering the extracted data for each identified stock photograph as an indexed item for each identified stock photograph, in a local database associated with the computer.

2. The method of claim 1, additionally comprising: creating the local database as associated with the computer, and storing the indexed item for each identified stock photograph, based on the extracted data, as a unique row in the local database.

3. The method of claim 2, wherein the extracted data includes at least one of: a description of the stock photograph and keywords associated with the stock photograph.

4. The method of claim 2, additionally comprising:
extracting attributes for each identified stock photograph from the main folder; and,
rendering the extracted attributes for each identified stock photograph as an indexed item for each identified stock photograph, in a local database associated with the computer.

5. The method of claim 4, additionally comprising: storing the indexed item for each identified stock photograph, based on the extracted attributes, in the unique row for the identified stock photograph, in the local database.

6. The method of claim 5, wherein the extracted attributes includes at least one of: file format, photograph size in pixels, photograph size in kilobytes, keywords associated with the photograph, photograph file source, and date of download of the photograph.

7. The method of claim 1, additionally comprising: prompting a user to define a folder as the main folder for stock photographs.

8. The method of claim 7, wherein the main folder includes at least one of: subfolders, photograph files, and data of photographs.

9. The method of claim 5 wherein the unique row for the identified stock photograph, in the local database includes metadata associated with the identified stock photograph, the metadata for the location of the data of the actual stock photograph.

10. The method of claim 1, wherein the destination includes a web site of at least one online stock photograph provider.

11. The method of claim 1, wherein the communications network includes the Internet.

12. The method of claim 1, wherein the computer includes a local computer.

13. A computer usable non-transitory storage medium having a computer program embodied thereon for causing a suitable programmed system to create a local database associated with a local computer linked to a communications network, by performing the following steps when such program is executed on the system, the steps comprising:
in a main folder associated with the computer, identifying stock photographs in the main folder;
determining the online stock photo service for each of the identified stock photographs;
accessing the stock photograph page for each of the identified stock photographs from a destination over the communications network;
extracting data from the stock photograph page for each of the identified stock photographs, over the communications network; and,
rendering the extracted data for each identified stock photograph as an indexed item for each identified stock photograph, in a local database associated with the computer.

14. The computer usable non-transitory storage medium of claim 13, the steps additionally, comprising:
creating the local database as associated with the computer, and,
storing the indexed item for each identified stock photograph, based on the extracted data, as a unique row in the local database.

15. The computer usable non-transitory storage medium of claim 14, wherein the extracted data includes at least one of: a description of the stock photograph and keywords associated with the stock photograph.

16. The computer usable non-transitory storage medium of claim 14, the steps additionally, comprising:
extracting attributes for each identified stock photograph from the main folder; and,
rendering the extracted attributes for each identified stock photograph as an indexed item for each identified stock photograph, in a local database associated with the computer.

17. The computer usable non-transitory storage medium of claim 16, the steps additionally comprising:
storing the indexed item for each identified stock photograph, based on the extracted attributes, in the unique row for the identified stock photograph, in the local database.

18. The computer usable non-transitory storage medium of claim 17, wherein the extracted attributes includes at least one of: file format, photograph size in pixels, photograph size in kilobytes, keywords associated with the photograph, photograph file source, and date of download of the photograph.

19. The computer usable non-transitory storage medium of claim 13, wherein the steps additionally comprise:
prompting a user to define a folder as the main folder for stock photographs; and, wherein the main folder includes at least one of: subfolders, photograph files, and data of photographs.

20. The computer usable non-transitory storage medium of claim 13, wherein the destination includes a web site of at least one online stock photograph provider.
